(19) United States
(12) Patent Application Publication
(10) Pub. No.: US 2014/0225362 A1
(43) Pub. Date: Aug. 14, 2014

(54) MULTIPLE SHADE LATENT IMAGES

(71) Applicant: Graphic Security Systems Corporation, Lake Worth, FL (US)

(72) Inventors: Cary M. Quinn, Wellington, FL (US); Slobodan Cvetkovic, Lake Worth, FL (US)

(21) Appl. No.: 14/176,818

(22) Filed: Feb. 10, 2014

Related U.S. Application Data
(60) Provisional application No. 61/762,669, filed on Feb. 8, 2013.

(51) Int. Cl. B42D 15/00; B41F 17/00

(52) U.S. Cl. CPC B42D 15/0073; B41F 17/00
USPC 283/85; 101/483

(57) ABSTRACT

Various examples are provided for creating encoded security images that are formed by embedding a multi-shade hidden or latent image into a visible image. The multi-shade latent image may include image content having a wide range of tonal values. An article of manufacture is provided having a surface with image elements thereon, the image elements include characteristics that correspond to a relative color or a relative shade of a source image for a polychromic or multiple shade latent image. The latent image is visible when the surface is viewed at glancing angles.

### CROSS-REFERENCE TO RELATED APPLICATIONS

This application claims priority to U.S. Provisional Application 61/762,669, filed Feb. 8, 2013, the complete disclosure of which is incorporated herein by reference in its entirety.

### FIELD OF THE TECHNOLOGY

The present disclosure relates generally to images, and more specifically to images having optical features applied to substrates, and still more specifically to latent images having multiple shade values, the latent images being applied to substrates to provide optical security features.

### BACKGROUND OF THE INVENTION

Latent images are known security features that are applied to banknotes, passports, and other documents of value. Latent images are commonly formed by varying a substrate surface geometry or by varying light transmittance properties of a substrate such that the latent images are visible with a naked eye when a surface of the substrate is viewed at preselected angles. For example, latent images can be formed using a process that creates raised or embossed structures in a substrate. Typical substrates onto which latent images are formed include currencies and passports formed by intaglio printing; paper formed using blind embossing; foil stamping; polycarbonate, metal, and other substrates formed by laser engraving, and coins and jewelry formed by CNC machines that create hubs and dies.

Security features that incorporate a latent image generally include two images that are each formed using image elements such as line segments. A first image is often called a visible image or background image and a second image is often called a latent image or a hidden image. Typically, the latent image is formed using image elements that are configured to run in a predefined direction such that the latent image is visible only when the surface of the security feature is viewed at non-perpendicular angles.

By contrast, the background image is formed using image elements that are configured to run in a different direction relative to the image elements of the latent image such that the background image is visible when the surface of the security feature is viewed at a perpendicular angle. For example, the image elements for the background image may be arranged in a first direction to pass light when the security feature is viewed at a perpendicular angle, while the image elements for the latent image may be arranged in a second direction to block light when the security feature is viewed at a perpendicular angle. Together, the image elements for the background image and the image elements for the latent image may form an elaborate design or a simple tint-like image. The latent image is usually embedded in the background image and the image elements of the latent image typically provide a simple message, such as text or a logo.

Multiple binary-shade latent images are known where each individual image is encoded at a predefined single angle. If a substrate is rotated while maintaining a glancing angle of view, the images will be seen in a sequence, one after another. Conventional security features are deficient at least because they fail to provide a latent image having image elements configured to render multiple shade values.

### SUMMARY OF THE INVENTION

According to one example, encoded security images formed by embedding a multi-shade hidden or latent image into a visible image. The multi-shade latent image may include image content having a wide range of tonal values. An article of manufacture is provided having a surface with image elements thereon, the image elements include characteristics that correspond to a relative color or a relative shade of a source image for a polychromic or multiple shade latent image. The latent image is visible when the surface is viewed at glancing angles.

According to another example, a method is provided for creating a multiple shade latent image that includes dividing a source image into a grid pattern having grid elements with corresponding image elements and averaging one of shade values or color values within the grid elements. An average shade value or an average color value is determined within the grid elements and image element characteristics are determined that correspond to the average shade value or the average color value. The image element characteristics are applied to the image elements within corresponding grid elements.

The latent images include image elements oriented to render multiple shade values. The latent images are characterized by variations in the surface geometry of a substrate upon which the image is placed. The latent image includes an arrangement of localized surface geometry variations that correspond to the relative shade of corresponding areas of the source image for the latent image.

### BRIEF DESCRIPTION OF THE DRAWINGS

The invention can be more fully understood by reading the following detailed description together with the accompanying drawings, in which like reference indicators are used to designate like elements, and in which:

FIG. 1 illustrates a latent image line screen embedded into a background line screen according to one example;

FIG. 2 illustrates a background line screen according to one example;

FIG. 3 illustrates a latent image line screen according to one example;

FIG. 4 illustrates a source image corresponding to the latent image in FIG. 3 according to one example;

FIG. 5A illustrates a diagram of viewing a latent image from a straight on perspective according to one example;

FIG. 5B illustrates a diagram of viewing a latent image from a glancing angle perspective according to one example;

FIG. 6A illustrates a latent image formed on a substrate according to one example;

FIG. 6B illustrates a magnified view of a portion of FIG. 6A with the latent image having image elements rotated a preselected amount relative to the shade level of the source image for the latent image;

FIG. 6C illustrates a magnified view of a portion of FIG. 6B according to one example;

FIG. 7 illustrates various image elements rotated a preselected amount corresponding to a light transmittance value according to one example;

FIG. 8A illustrates a latent image formed on a substrate according to one example;

FIG. 8B illustrates a visible image formed on a substrate according to one example;

FIG. 8C illustrates a magnified view of a combined image that includes a portion of the latent image of FIG. 8A and a portion of the visible image of FIG. 8B having image elements rotated a preselected amount relative to the percentage shade of the source image for the latent image;

FIG. 8D illustrates an exploded view of a portion of FIG. 8C having the combined image elements rotated a preselected amount relative to the percentage shade of the source image for the latent image;

FIG. 9A illustrates a coin viewed from a first perspective, the coin having parallel furrows that render binary latent images when viewed from different perspectives;

FIG. 9B illustrates the coin viewed from a second perspective, the coin having parallel furrows that render binary latent images when viewed from different perspectives;

FIG. 10A illustrates a cross section of parallel furrows having triangular profiles for creating two latent images when viewed from corresponding side perspective according to one example;

FIG. 10B illustrates a cross section of parallel furrows corresponding to the coin in FIG. 9B, the parallel furrows having triangular profiles for creating two latent images when viewed from corresponding side perspective according to one example;

FIGS. 11A-C illustrates cross sections of a substrate according to one example having parallel furrows with triangular profiles that have varying inclination angles based on a shade value for corresponding grid elements in a source image for the latent image;

FIG. 12 illustrates a top view of pyramid structures according to one example having a square base and four faces that may be configured to accommodate multiple shade latent images thereon using patterns on different faces to represent image content.

FIG. 13 illustrates a perspective view of pyramid structures according to one example having a square base and four faces that may be configured to accommodate multiple shade latent images thereon using patterns on different faces to represent image content.

FIG. 14 illustrates a top view of pyramid structures according to one example having a square base and four faces that may be configured to accommodate multiple shade latent images thereon using different face inclination angles to signify represent content.

FIG. 15 illustrates a perspective view of pyramid structures according to one example having a square base and four faces that may be configured to accommodate multiple shade latent images thereon using different face inclination angles to represent image content.

FIG. 16 illustrates a top view of pyramid structures according to one example having a square base and four faces that may be configured to accommodate multiple shade latent images thereon using patterns on different faces and rotating the pyramid structures to represent image content.

FIG. 17 illustrates a perspective view of pyramid structures according to one example having a square base and four faces that may be configured to accommodate multiple shade latent images thereon using patterns on different faces and rotating the pyramid structures to represent image content.

FIG. 18A-C illustrates a cross section of a substrate according to one example having concave features with different feature depths, the depths of three successive cells is varied from light to dark based on an average shade value for corresponding grid elements in a latent image varies.

### DETAILED DESCRIPTION OF THE INVENTION

It will be readily understood by persons skilled in the art that the present disclosure has broad utility and application. In addition to the specific examples described herein, one of ordinary skill in the art will appreciate that this disclosure supports various adaptations, variations, modifications, and equivalent arrangements.

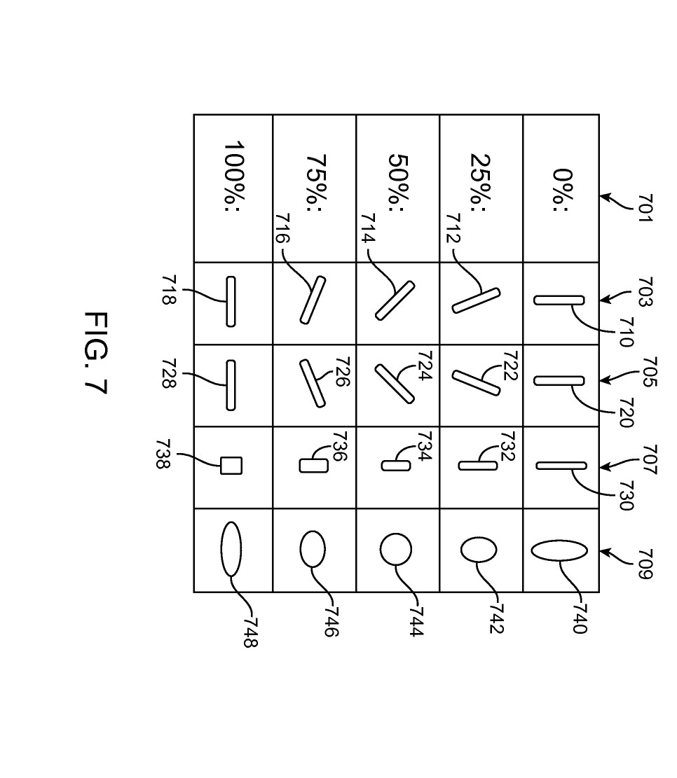

This disclosure describes examples for creating encoded security images that are formed by embedding a multi-shade hidden or latent image into a visible image. The multi-shade latent image may include image content having a wide range of tonal values. In one example described with reference to FIGS. 6A-6C below, the content area of the latent image may be sub-divided into a mesh or grid pattern. Each grid element may include a corresponding image element therein. According to one example, each grid element may be dimensioned to cover a predefined image content area, such as, for example, a 10×10 pixel area or other image feature area. Collectively, the plurality of grid elements defines the image content area for the latent image and the plurality of image elements defines density values corresponding to the image content for the latent image.

By contrast, conventional latent images include image content having two tonal values. Accordingly, the image elements for the latent image are oriented in two directions relative to image elements for the visible or background image. For example, when the image elements for the latent image are oriented to correspond to a direction of the image elements for the background image, then the image elements for the latent image are in an “on” position to pass light there through. Alternatively, when the image elements for the latent image are oriented at a relative angle compared to the image elements for the background image, then the image elements for the latent image are in an “off” position that obscures light.

A latent image having multi-shade image elements is visually more appealing compared to latent images having only two shade image elements such as, for example, 0% transmittance (“off”) and 100% transmittance (“on”). Throughout this disclosure, the terms multi-shade or multiple shade are used as synonyms for a monochrome. This disclosure supports latent images that include shades of any color or colors, in addition to shades of gray. Also, throughout this disclosure, the terms “shade,” “tone,” and “tint” are used interchangeably. A shade level or a tonal value is used to refer to the level of lightness, darkness, and grayness.

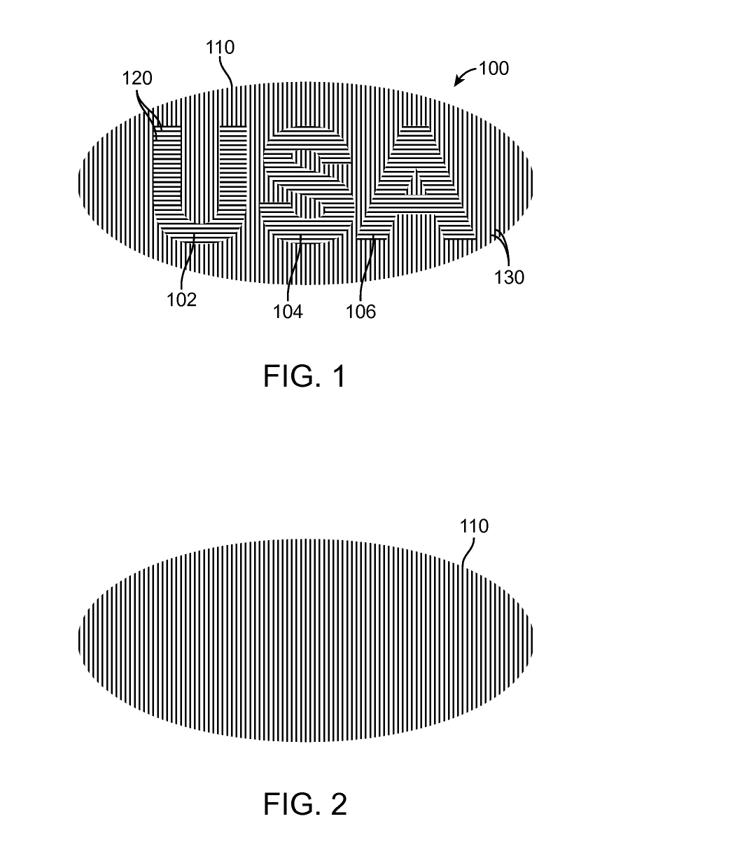

FIG. 1 illustrates an encoded security image 100 that includes a latent image created using horizontal lines that represent letters “U” 102, “S” 104, and “A” 106. Additionally, the encoded security image 100 includes a background image 110 created using vertical lines surrounding the letters “U” 102, “S” 104, and “A” 106. In one example, the latent image represented by letters “U” 102, “S” 104, and “A” 106 may be applied as a mask to the background image 110.

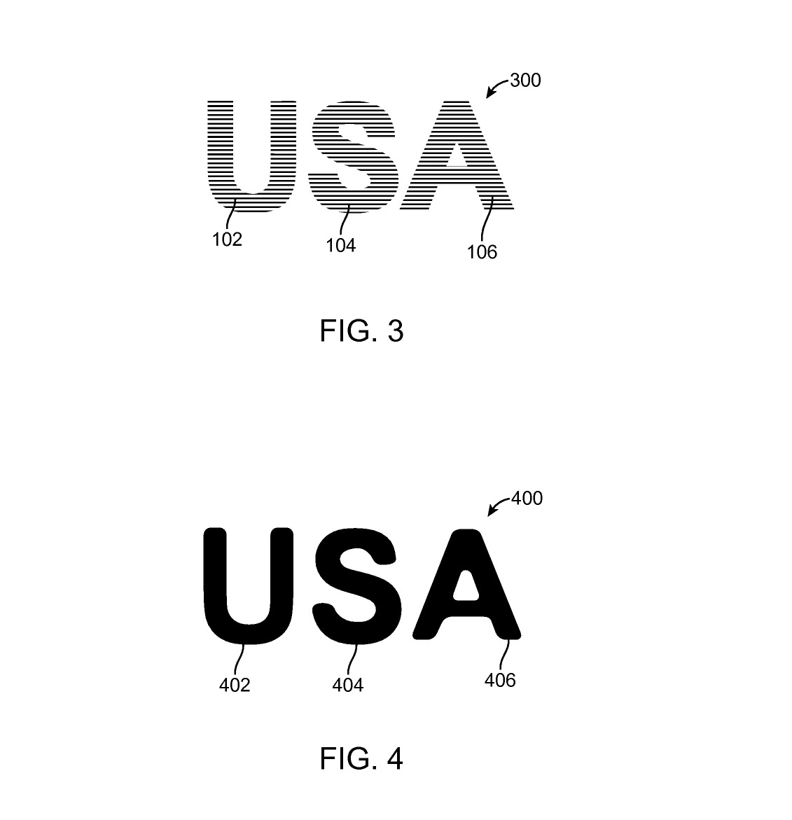

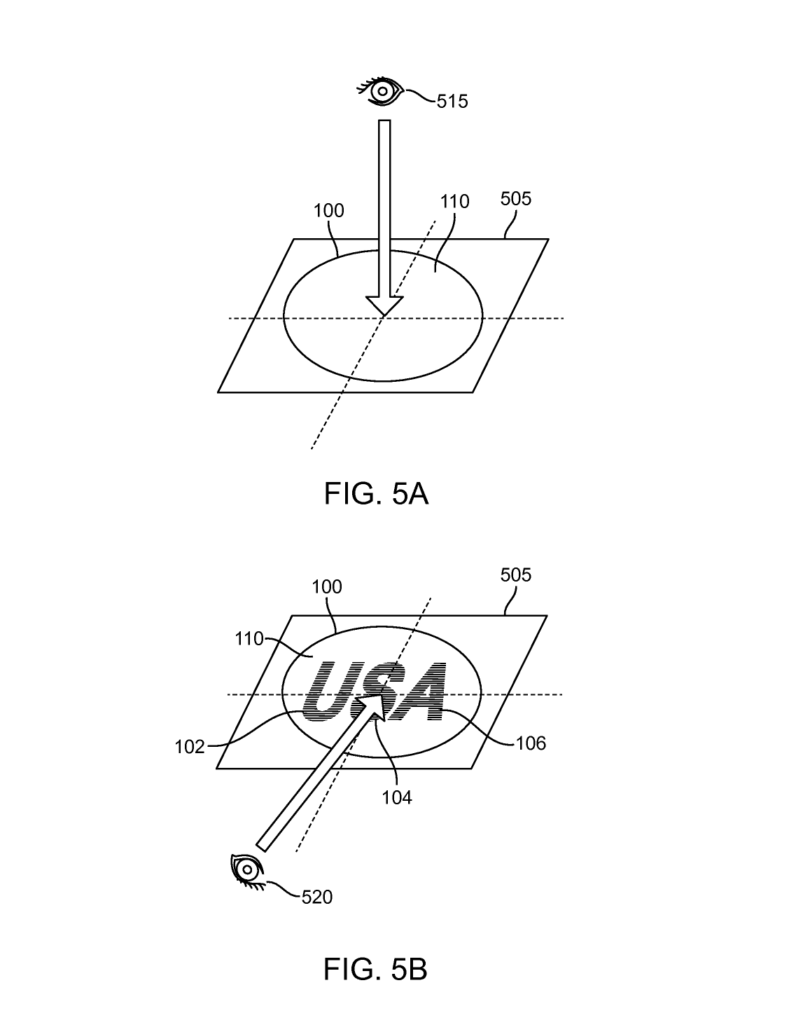

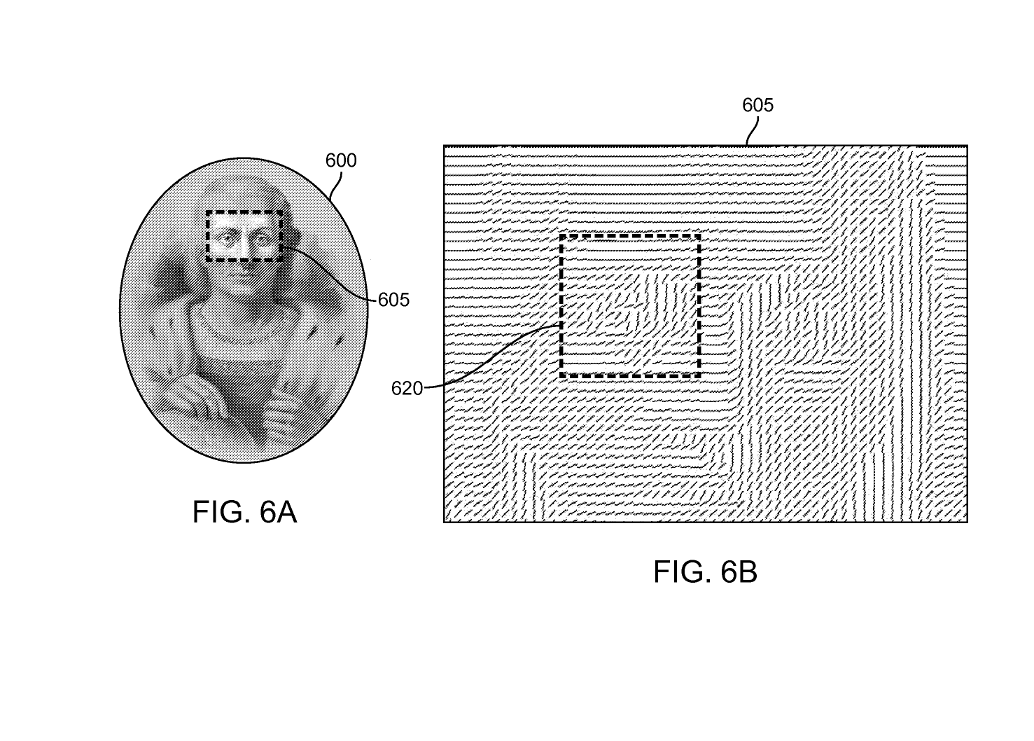

FIG. 2 illustrates the background image 110 by itself without the latent image embedded therein. In one example, the background image 110 may be formed using intaglio printing or laser engraving, among other techniques. FIG. 3 illustrates a latent image 300 by itself represented by letters “U” 102, “S” 104, and “A” 106. In one example, the latent image 300 may be formed using intaglio printing or laser engraving, among other techniques. FIG. 4 illustrates a source image 400 for the latent image 300, the source image 400 being represented by letters “U” 402, “S” 404, and “A” 406. The source image 400 is used to obtain the latent image 300.

Returning to FIG. 1, the encoded security image 100 is visually represented using a binary latent image that contains a text or logo represented by the letters “U” 102, “S” 104, and “A” 106. The image elements or line segments 120 of the latent image inside the mask of the background image 110 are rotated by a predefined angle relative to the image elements 130 of the background image 110 to create the encoded security image 100. Specifically, the encoded security image 100 is formed by rotating the image elements 120 of the latent image represented by letters “U” 102, “S” 104, and “A” 106 in a direction that is perpendicular relative to a direction of image elements 130 used to form the background image 110. Alternatively, the latent image may be formed using image elements that are rotated to run at a predefined fixed angle relative to the direction of the image elements 130 used to form the background image. Additionally, while FIG. 1 represents the image elements 120,130 for the latent image and the background image 110 as being alternate black and white lines, one of ordinary skill in the art will readily appreciate that the image elements 120,130 may be represented using different shading characteristics.

According to one example, the background image 110 and the latent image embedded within the background image 110 may be created using image elements having similar patterns, properties, features, or the like. As illustrated in FIG. 1, the image elements 130 corresponding to the background image 110 and the image elements 120 within the mask that corresponds to the latent image are positioned at fixed angular orientations relative to each other. For example, the image elements 120 within the mask that correspond to the letters “U” 202, “S” 204, and “A” 206, are rotated relative to the image elements 130 of the background image 110 by a predefined fixed angle to create the encoded security image 100. The predefined fixed angle may be selected as any angle. As illustrated in FIG. 1, the predefined fixed angle is uniformly applied to rotate the image elements 120 within the mask that correspond to the letters “U” 202, “S” 204, and “A” 206 relative to the image elements 130 of the background image 110. For example, the predefined fixed angle may be any angle between 0° and 180°. For example, the predefined fixed angle may be 30°, 60°, 90°, 120°, 150°, 180°, among other angles.

According to one example, the image elements 120,130 may be configured as straight line segments, wavy line segments, zigzag line segments, concentric ring line segments, or any other image element configuration. In one example, the image elements may include a uniform thickness. Alternatively, the image elements may include a varied thickness. For example, the varied thickness may follow a desired pattern.

According to another example, the image elements may include elongated structures such as an ellipsis or an elongated diamond, among other image elements. Further still, the image elements may be formed from other structures or combination of structures that produce different levels of occlusion when the angle of view is modified. For example, image elements may be formed using clustered dots that to form lines or other shapes; dots that are not clustered together but are selectively positioned to create occlusion in certain areas; and a screen of asymmetrical shapes; among other image element structures.

According to one example, the image elements 120 for the latent image may be configured to produce a color shade that matches the color shade for the image elements 130 used to produce the background image 110. Furthermore, if adjacent image elements 120 used to create the latent image are spaced further apart from each other compared to adjacent image elements 130 used to create the background image 110, then the image elements 120 for the latent image may be made proportionally thicker than the image elements 130 for the background image 110. In this case, an observer's eyes will blend the image elements 120 for the latent image and the image elements 130 for the background image 110 into a same color shade despite the image elements 130 for the background image 110 being more numerous and thinner.

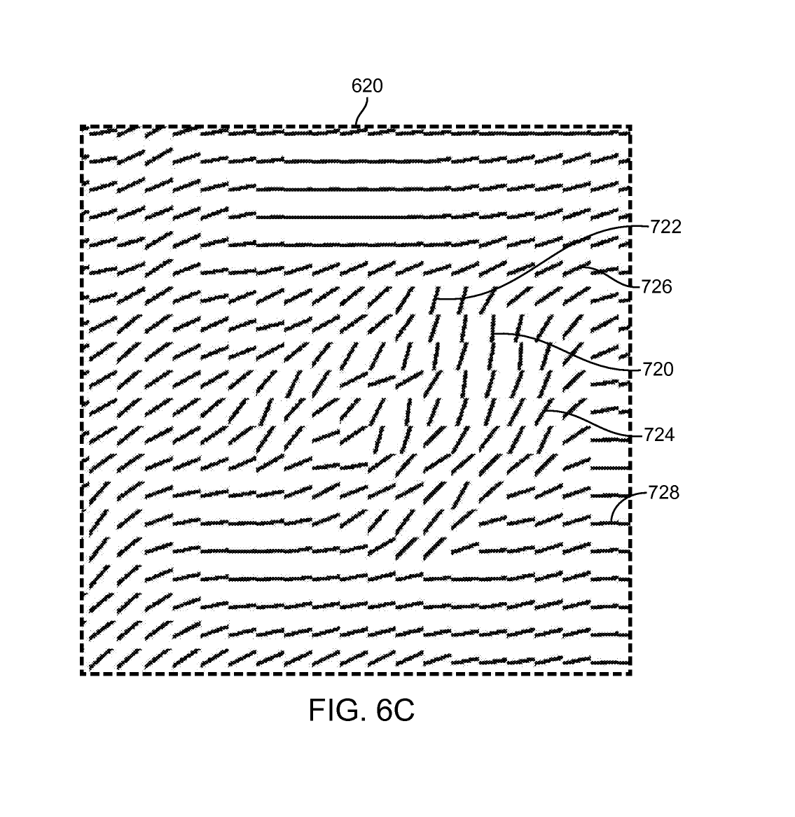

FIG. 5A illustrates a diagram in which a substrate 505 having the encoded security image 100 is viewed from an angle perpendicular to a plane of the substrate 505. When the substrate 505 is viewed from this straight-on perspective 515, an observer of the encoded security image 100 will only see the background image 110 and will not see the hidden or latent image. According to one example, the latent image is hidden when viewed from this perpendicular perspective 515 because image elements of the background image 110 that are replaced by the image elements of the latent image have color shades that match the color shades of the background image 110.

FIG. 5B illustrates a diagram in which the substrate 505 having an encoded security image 100 is viewed from the perspective of glancing angle 520. According to one example, when the substrate 505 is tilted at an angle of approximately 0° or 180° to provide the glancing angle 520, raised image elements provided on the substrate 505 create variations in occlusion of the substrate 505 that separates the latent image from the background image 110. For example, the variations in occlusion may produce a shadow that separates the latent image from the background image 110. In this disclosure, the term occlusion is defined to mean an obstruction of a viewer's line of sight.

According to one example, the obstruction may be caused by light rays reflecting off image elements provided on the substrate 505 such that the reflected light makes portions of the image elements less visible compared to other portions of the image elements. Alternatively, the obstruction may be caused by light rays passing through portions of the image elements such that passing light makes portions of the image elements less visible compared to other portions of the image elements. In one example, if the light rays pass through image elements configured parallel to a line of sight, then the light rays are partially occluded by image elements running at an angle relative to a line of sight. This occlusion creates a contrast difference between the image elements 130 associated with the background image 110 and the image elements 120 associated with the latent image. This contrast difference causes the latent image to become visible to an observer.

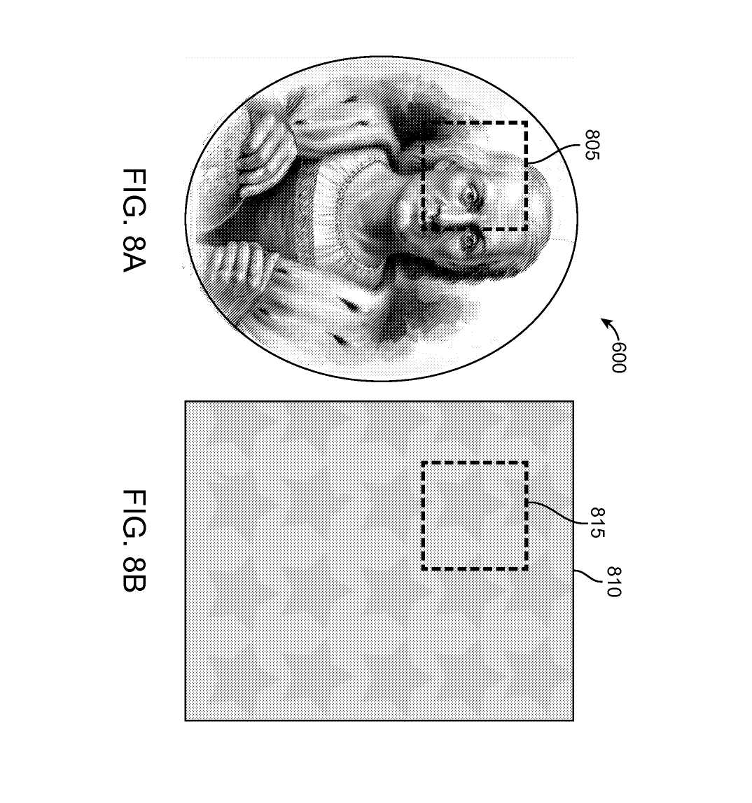

FIG. 6A illustrates a source image 600 for a multi-shade latent image having a first focus region 605 positioned over the source image 600. FIG. 6B illustrates an enlarged first focus region 605 to illustrate that the source image 600 is sub-divided into a grid pattern having a plurality of image elements. FIG. 6B illustrates a second focus region 620 positioned over the enlarged first focus region 605. FIG. 6C illustrates the second focus region 620 corresponding to the source image 600 of the multi-shade latent image at a higher magnification than the same area illustrated within the first focus region 605. The second focus region 620 illustrates that the source image 600 is sub-divided into a grid pattern having a plurality of image elements with varying characteristics as described with reference to FIG. 7.

FIG. 7 illustrates different techniques for modifying characteristics of image elements provided within corresponding grid elements illustrated in FIGS. 6A-6C. The image element characteristics are modified to convey proportional changes to desired tonal values for the latent image. For example, the image element characteristics may be modified to correspond to a plurality of transmittance values. In one example, the image element characteristics are adjusted by changing a rotation angle of image elements, changing an elongation or shape of image elements, changing a depth that the image elements penetrate into a substrate, changing a slope of the image elements, changing a perforation characteristic of the image elements, and changing an embossing characteristics of the image elements, among other techniques for changing image element characteristics.

According to one example, changing the rotation angle of the image elements may be suited for intaglio printing or laser engraving, among other techniques. According to another example, changing the elongation or shape of the image elements may be suited for intaglio printing or perforation, among other techniques. According to yet another example, changing the depth that the image elements penetrate into a substrate may be suited for intaglio printing or embossing, among other techniques. One of ordinary skill in the art will readily appreciate that a multitude of printing or image creation methods may be used including, for example, intaglio, embossing, perforation, laser engraving, laser ablation as well as a computer numerical control (“CNC”) machine, or the like. One of ordinary skill in the art will readily appreciate that changing the image element characteristics may be accomplished using various other techniques.

FIG. 7 illustrates a plurality of exemplary transmittance values in column 701, including 0% transmittance, 25% transmittance, 50% transmittance, 75% transmittance, and 100% transmittance. According to one example, the image elements illustrated in column 703 are configured to correlate to a 90° or vertical image element 710 for 0% transmittance; a 67.5° image element 712 for 25% transmittance; a 45° image element 714 for 50% transmittance; a 22.5° image element 716 for 75% transmittance; and a 0° or horizontal image element 718 for 100% transmittance. One of ordinary skill in the art will readily appreciate that a greater number of transmittance values or a lesser number of transmittance values may be correlated to the image elements.

According to another example, the image elements illustrated in column 705 are configured to correlate to a 90° or vertical image element 720 for 0% transmittance; a 112.5° image element 722 for 25% transmittance; a 135° image element 724 for 50% transmittance; a 157.5° image element 726 for 75% transmittance; and a 180° or horizontal image element 728 for 100% transmittance. One of ordinary skill in the art will readily appreciate that a greater number of transmittance values or a lesser number of transmittance values may be correlated to the image elements.

FIG. 7 further illustrates image elements in column 707 that may be configured to correlate 0% transmittance to an image element 730 having a first elongation value; correlate 25% transmittance to an image element 732 having a second elongation value; correlate 50% transmittance to an image element 734 having a third elongation value; correlate 75% transmittance to an image element 736 having a fourth elongation value; and correlate 100% transmittance to an image element 738 having a fifth elongation value. According to one example, the image elements 730-738 may be dimensioned to have a same surface area so that image elements 730-738 are perceived to uniformly blend into the latent image. One of ordinary skill in the art will readily appreciate that a greater number of transmittance values or a lesser number of transmittance values may be correlated to the image elements.

Furthermore, the image elements illustrated in column 709 may be configured to correlate 0% transmittance to an image element 740 having a first elongation value; correlate 25% transmittance to an image element 742 having a second elongation value; correlate 50% transmittance to an image element 744 having a third elongation value; correlate 75% transmittance to an image element 746 having a fourth elongation value; and correlate 100% transmittance to an image element 748 having a fifth elongation value. According to one example, the image elements 740-748 may be dimensioned to have a same surface area so that image elements 740-748 are perceived to uniformly blend into the latent image. One of ordinary skill in the art will readily appreciate that a greater number of transmittance values or a lesser number of transmittance values may be correlated to the image elements. Furthermore, one of ordinary skill in the art will readily appreciate that other characteristics, properties, or features may be assigned to correlate the image elements to selected transmittance values. Still further, one of ordinary skill in the art will readily appreciate that other techniques may be applied to encrypt a hidden message and to decipher a hidden message based on assigning various characteristics, properties, or features to the image elements.

Returning to FIG. 6C, the image elements 720-728 identified in the enlarged second focus region 620 correspond to the image elements 720-728 illustrated in column 705 of FIG. 7. The image elements 720-728 illustrated within the enlarged second focus region 620 of the multi-shade latent image are rotated by preselected angles based on a relative shade level of the source image 600. The image elements 720-728 identified in FIG. 6C are placed within grid elements throughout the image content and depict multiple shade levels within the multi-shade latent image. The image elements 720-728 identified in FIG. 6C may be formed using intaglio printing, which provides raised or embossed surfaces on a substrate having the source image 600 placed thereon. Alternatively, the image elements 720-728 may be formed by laser engraving or other technique.

According to one example, the multi-shade latent image illustrated within the enlarged second focus region 620 is created using localized angle variations of the image elements 720-728. The grid elements containing the image elements 720-728 are used to sub-divide the image content into smaller cells so that a single image element or line segment may be place into a corresponding grid element or grid cell. One of ordinary skill in the art will readily appreciate that more than one image element may be place within a grid element. One of ordinary skill in the art will further appreciate that a portion of an image element may be placed within a grid element. Furthermore, one of ordinary skill in the art will readily appreciate that any of a number of grid patterns or configurations may be used. For example, a grid pattern may include a square grid pattern, a rectangular grid pattern, a hexagonal grid pattern, or the like. With respect to image elements, any image element characteristic may be used within the grid elements, such as elongated diamonds, ellipsis, or the like.

Within the enlarged second focus region 620 of FIG. 6C, the image elements 720-728 of the multi-shade latent image are shown rotated within corresponding grid elements relative to image elements provided in the background image. According to one example, the image elements 726,728 may be selected to correspond to lighter sections of the source image for the multi-shade latent image. As illustrated in FIG. 7, the image elements 726,728 are configured in a substantially horizontal orientation to provide 100% or 75% transmittance. By contrast, the image elements 720,722 may be selected to correspond to darker sections of the source image for the multi-shade latent image. As illustrated in FIG. 7, the image elements 720,722 are configured in a substantially vertical orientation to provide 0% or 25% transmittance.

According to one example, if the substrate having the encoded security image is viewed from a glancing angle of 0° or 180°, for example, then substantially vertical image elements 720,722 will occlude light and will create dark shades in the observed encoded security image. By contrast, when the encoded security image is viewed from the same glancing angle, then the substantially horizontal image elements 726,728 will minimally occlude light and will create lighter shades in the observed encoded security image. Alternatively, if the substrate having the encoded security image is viewed at an glancing angle perpendicular or 90° to a glancing angle previously used, then an observer will perceive a multiple shade latent image that is inverted compared to a corresponding input image.

According to one example, an amount of contrast between the latent image and the background image may be controlled by adjusting an angle of the image elements for the latent image relative to an angle of the image elements for the background image. Typically, a large contrast is achieved when the angular difference between the image elements for the latent image and the image elements for the background image is 90 degrees. According to one example, the amount of contrast between the image elements for the latent image and the image elements for the background image may be maintained constant throughout the encoded security image for a selected angle of view by maintaining a fixed angular difference between the image elements for the latent image and the image elements for the background image.

According to one example, if the source image 600 corresponding to the multi-shade latent image is formed using pixels, then pixel values may be averaged within corresponding grid elements. An average pixel value within corresponding grid elements may be correlated to a transmittance value and mapped to selected image elements 220-228 having desired rotation angles. According to one example, the following equation is provided to calculate an image element rotation angle within a corresponding grid element based on an amount of contrast determined from the average pixel value:

angle=minAngle+avgDensity*(maxAngle−minAngle)/(maxDensity−minDensity)

In this equation, minAngle corresponds to a minimum selected angle associated with transmittance; maxAngle corresponds to a maximum selected angle associated with transmittance; minDensity corresponds to a minimum shade level for a grid element of the source image 600 for the multiple shade latent image; maxDensity corresponds to a maximum shade level for a grid element of the source image 600 for the multiple shade latent image; avgDensity corresponds to an average pixel density for a given grid element within the source image 600 for the multiple shade latent image; and angle corresponds to a rotation angle of the image element for a given grid element within the source image 600 for the multiple shade latent image. Furthermore, the rotation angle of the image elements, as well as the boundary angles (minAngle, maxAngle) in this formula may be substituted by elongation of the image elements, depth of the image elements, perforation angle of the image elements, slope of the image element, or inclination angle of the image element.

According to one example, a grid pattern may be placed over the source image 600 of the multiple shade latent image. If the source image 600 includes multiple shade levels having transmittance values ranging from 0 to 100%, then the transmittance values may be mapped to a plurality of image elements using a full angle rotation range of 0° to 90° as illustrated in column 703 of FIG. 7. In this example, an image element may be rotated by 90° to provide a large shade contrast at 0% transmittance. Otherwise, the image elements may be rotated by proportionally smaller angle ranges to provide less shade contrast. According to one example, FIG. 7 at column 703 supports rotation angles of 0°, 22.5°, 45°, or 67.5° for transmittance values of 0%, 25%, 50%, and 75%, respectively. One of ordinary skill in the art will readily appreciate that a greater number or a lesser number of rotation angles may be used.

While the above equation is linear, one of ordinary skill in the art will readily appreciate that this disclosure supports applying log, exponential, parabolic, or any other functions or equations for a variety of applications. One of ordinary skill in the art further appreciates that this disclosure is not limited to applying linear equations for mapping density values to image element rotation angles.

According to one example, a selected mapping equation may be configured to accommodate known sensitivities by applying a log scale equation instead of a linear scale equation when mapping a shade level value onto an image element rotation angle. For example, research shows that the human eye is more sensitive to detecting changes in dark shades compared to detecting changes in bright shades. Accordingly, a log scale equation may be applied to accommodate for human eye characteristics that are more likely to notice a change in shade level between 10% and 15% as compared to a change in shade level between 85% and 90%. This disclosure further contemplates applying a digital device specific response function to map shade levels and image element rotation angles when the digital device is used to authenticate an encoded security image.

According to another example, a range of rotation angles from 30° to 60° may be used in place of a range of rotation angles from 0° to 90°. Under this restricted range of rotation angles, the minAngle and maxAngle values in equation 1 above will need to be adjusted accordingly. One of ordinary skill in the art will readily appreciate that this disclosure supports any range of rotation angles between 0° to 360°. Additionally, the multiple shade values may be expressed in different units. For example, one representation may be to assign a value of 0 to black, which corresponds to 0% transmittance in the above equation. Furthermore, a value of 255 may be assigned to white, which corresponds to 0% transmittance in the above equation. One of ordinary skill in the art will readily appreciate that any values identified for use with equation 1 above may be replaced by a new set of range boundaries that may be applied to calculate a rotation angle for each cell element. Furthermore, while the unit of degrees is applied to express an angle range in equation 1, one of ordinary skill in the art will readily appreciate that this disclosure is not restricted to applying a unit of degrees to express an angle range. Any other unit capable of expressing degrees is supported by this disclosure.

If a glancing angle is used that goes along the vertical lines, or any other predetermined position that is different from the glancing along horizontal lines, this glancing angle may be selected as a default viewing angle for the authentication of the encoded security image. In this case, the referent axis (zero-angle axis) used for the angle calculation may be changed to match this viewing angle.

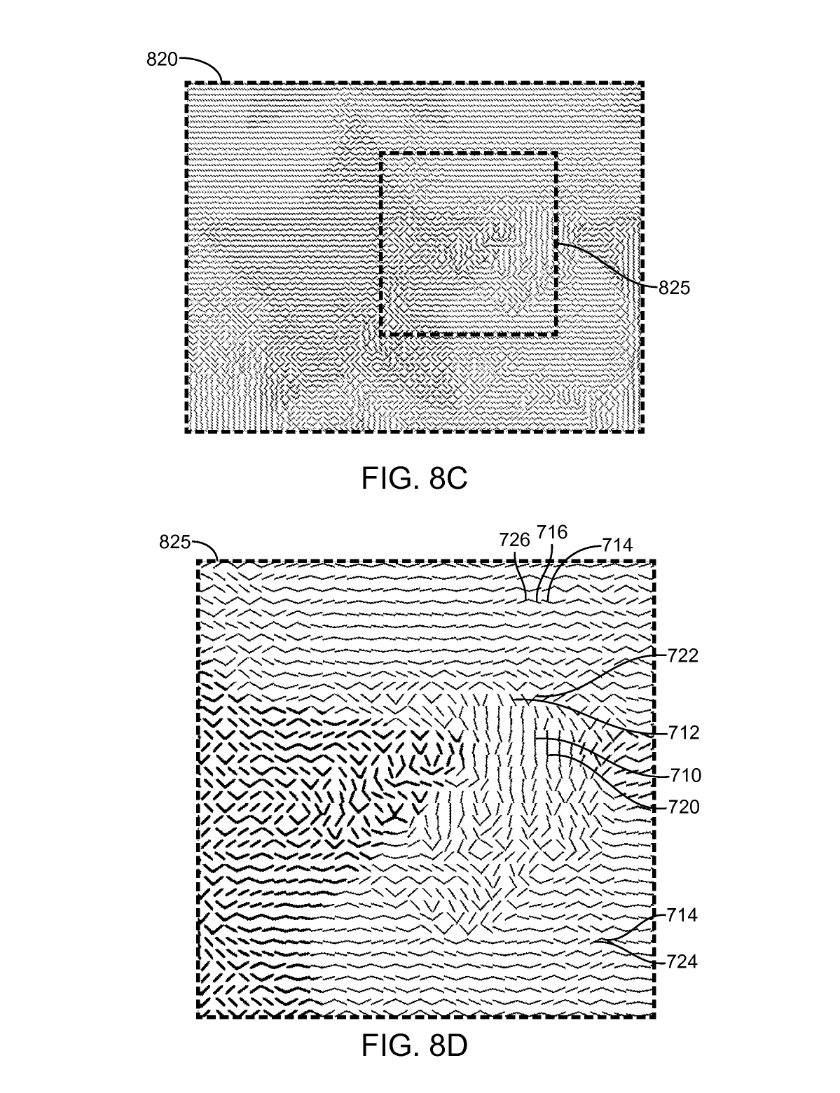

FIG. 8A illustrates a source image 600 for the multi-shade latent image having a first source focus region 805 positioned over the source image 600. FIG. 8B illustrates a visible image 810 having a first visible focus region 815 positioned over the visible image 810. FIG. 8C illustrates a first combined enlarged area 820 to illustrate that the first combined enlarged area 820 is sub-divided into a grid pattern having a plurality of image elements. A second focus region 825 is positioned over the first combined enlarged area 820. FIG. 8D illustrates a combined enlarged second focus region 825 corresponding to the same area illustrated within the first combined enlarged area 820 at a higher magnification than the first combined enlarged area 820. The combined enlarged second focus region 825 illustrates that the first combined enlarged area 820 is sub-divided into a grid pattern having a plurality of image elements with varying characteristics as described with reference to FIG. 7.

As discussed above with reference to FIGS. 6A-6C, different techniques are provided for modifying characteristics of image elements provided within corresponding grid elements illustrated in FIGS. 8A-8D. The background image 810 may include a multiple shade image having multicolor content. The content provided in the background image 810 may be used to control a thickness or boldness factor of the image elements in each grid element. Furthermore, the content provided in the source image 600 of the multi-shade latent image may be used to control a rotation angle of image elements. According to one example, the background image 810 may be visible with a straight-on view and multi-shade latent image will appear at appropriate glancing views.

In one example, the image element characteristics may be adjusted by changing a rotation angle of image elements, changing an elongation or shape of image elements, changing a depth that the image elements penetrate into a substrate, changing a perforation characteristic of the image elements, and changing an embossing characteristics of the image elements, among other techniques for changing image element characteristics. According to one example, changing the rotation angle of the image elements may be suited for intaglio printing or laser engraving, among other techniques. According to another example, changing the elongation or shape of the image elements may be suited for intaglio printing or perforation, among other techniques. According to yet another example, changing the depth that the image elements penetrate into a substrate may be suited for intaglio printing or embossing, among other techniques. One of ordinary skill in the art will readily appreciate that changing the image element characteristics may be accomplished using various other techniques.

Referring to the background image 810 in FIG. 8B, the “stars” design is used to control a thickness or boldness factor of the image elements inside the encoded security image. The thickness of the raised or embossed surfaces may be modulated to create a background image with multiple shade values. According to one example, a thickness of the image elements is made thicker where the background image 810 is darker, such as where the stars are present. According to one example, the source image 600 of the multi-shade latent image is used to control a rotation angle of image elements, such that more rotation is provided to image elements in darker areas. Furthermore, the image elements may be rotated either clockwise or counter-clockwise.

When a glancing view of the substrate is directed along horizontally oriented image elements, the image elements that are rotated in a counter-clockwise direction by an amount (−) negative angle will be perceived to create a substantially similar amount of light occlusion as compared to image elements that are rotated in a clockwise direction by an equal amount (+) positive angle. With reference to FIG. 7, when the image elements illustrated in columns 703 and 705 of FIG. 7 are applied to create the image provided in the combined enlarged area second focus region 825, a human observer will perceive corresponding image elements 710 and 720 as having substantially similar transmittance values. Similarly, a human observer will perceive corresponding image elements 712 and 722 as having substantially similar transmittance values; corresponding image elements 714 and 724 as having substantially similar transmittance values; corresponding image elements 716 and 726 as having substantially similar transmittance values; and corresponding image elements 718 and 728 as having substantially similar transmittance values. This effect can be utilized in different ways. According to one example, a user can randomly select whether to rotate an image element by (−) angle or by (+) angle degrees to achieve improved blending and a smoother appearance of the encoded security image.

Another application for applying counter-clockwise and clockwise rotated image elements without changing an appearance of the encoded security image is to embed a hidden message into the encoded security image. According to one example, hidden messages can be encoded using a binary code such that a clockwise rotation of an image element may be applied at grid cells where there is a “zero” in the hidden message. Alternatively, a counter-clockwise rotation of the image element may be applied at grid cells where there is a “one” in the hidden message. The system may adjust for rotations by zero degrees (non-rotations), since this image element may be ambiguous. According to one example, a curve may be applied at the multiple shade latent image to eliminate white areas corresponding to non-rotation. Another approach may be to build a redundancy in the hidden message using Reed-Solomon coding or similar approach. Accordingly, any errors introduced in the white areas may be corrected. Another variation may be to move the image element slightly off-center for one of the binary symbols and use this positioning to make a distinction between coded “one” or coded “zero” in the hidden message.

According to one example, an optical scanner may be programmed to differentiate the different angles existing between corresponding image element pairs 710 and 720; the different angles existing between corresponding image element pairs 712 and 722; the different angles existing between corresponding image element pairs 714 and 724; the different angles existing between corresponding image element pairs 716 and 726; and the different angles existing between corresponding image element pairs 718 and 728. Accordingly, the optical scanner may be programmed to decipher a hidden message carried by relative orientations of the image elements. For example, the image elements that render the latent image may be configured as a bar code. When the encoded security image having the hidden image is scanned by a bar code reader, a hidden message may be obtained. One of ordinary skill in the art will readily appreciate that other techniques may be applied to encrypt a hidden message and to decipher the hidden message based on assigning various characteristics, properties, or features to the image elements. The hidden message will not be readily perceived by a human observer that is unable to distinguish differences in angles existing between corresponding image element pairs.

Referring to the background image 810 in FIG. 8B, a dynamic range of the background image content may be made small and may emphasize a highlights side. According to one example, if the image elements in the background image 810 are made very thick to represent very dark shades, these thick image elements may cause light occlusion for a glancing view. As a result, it may be difficult to distinguish between an occlusion originating from image element rotation characteristics associated with content of the source image 600 multi-shade latent image and occlusions originating from the image element thickening associated with content from the background image 810. To minimize this uncertainty, a full density value range may be used inside the background image 810, but a restriction may be place on an image element thickness within a corresponding grid element. For example, the image element thickness may be maintained significantly below 100% coverage.

According to one example, image element characteristics may be modified to convey proportional changes to desired tonal values for the latent image. For example, the image element characteristics may be modified to correspond to a plurality of transmittance values. In one example, the image element characteristics are adjusted by changing a rotation angle of image elements, changing an elongation or shape of image elements, changing a depth that the image elements penetrate into a substrate, changing a perforation characteristic of the image elements, and an changing embossing characteristics of the image elements, among other techniques for changing image element characteristics.

According to one example, the combined image 820 may be formed on a substrate using raised or embossed surfaces. For example, the combined image 820 may be formed on the substrate by intaglio printing or laser engraving, among other techniques. The combined image 820 illustrates image elements that correspond to the latent image and image elements that correspond to the visible image 810. The image elements in the combined image 820 may be rotated a preselected amount relative to the image elements of the background image 810 based on a shade value of the source image for the multi-shade latent image. A thickness of raised or embossed surfaces on the substrate may be modulated to create a combined image 820 with multiple shade values.

As discussed above with reference to FIGS. 6A-6C, a full angle rotation range of 0° to 90° may not be needed to encode average shade values within corresponding grid elements of the latent image. According to one example, the angle rotation range may be divided into several angle range sections and the mapping grid may be divided into an equivalent number of subsets. Each angle range section and corresponding grid subset may be used to map a different shade latent image. According to one example, the glancing angle may be adjusted to obtain an optimal view for each of these multiple latent images.

According to another example, the latent image may be designed as a construction of multiple monochrome latent image components made of different colors. The multiple monochrome latent image components may be combined to form one complete polychrome latent image effect when viewed at non perpendicular angles. This process may be achieved similar to how a CMYK half-toning process creates a full color image from the construction of multiple elements in different shades. Each color separation may be separately processed by the monochrome latent image software to reflect the color densities for each different separation.

According to one example, the latent image in FIGS. 6A-6C may become a monochrome latent image after processing one separation, such as cyan. The monochrome latent image may be constructed with elements of a corresponding color such that a cyan separation is processed with the background image 605 for the cyan separation and is printed and/or imaged with cyan elements. This process may be repeated for each other color separation (M, Y, & K). When compiled together and viewed at a non-perpendicular angle, the latent image effects for each color separation may align to form a complete polychrome image rather than a monochrome image. The separate latent image results from each color separation may be compiled as overlapping or adjacent elements.

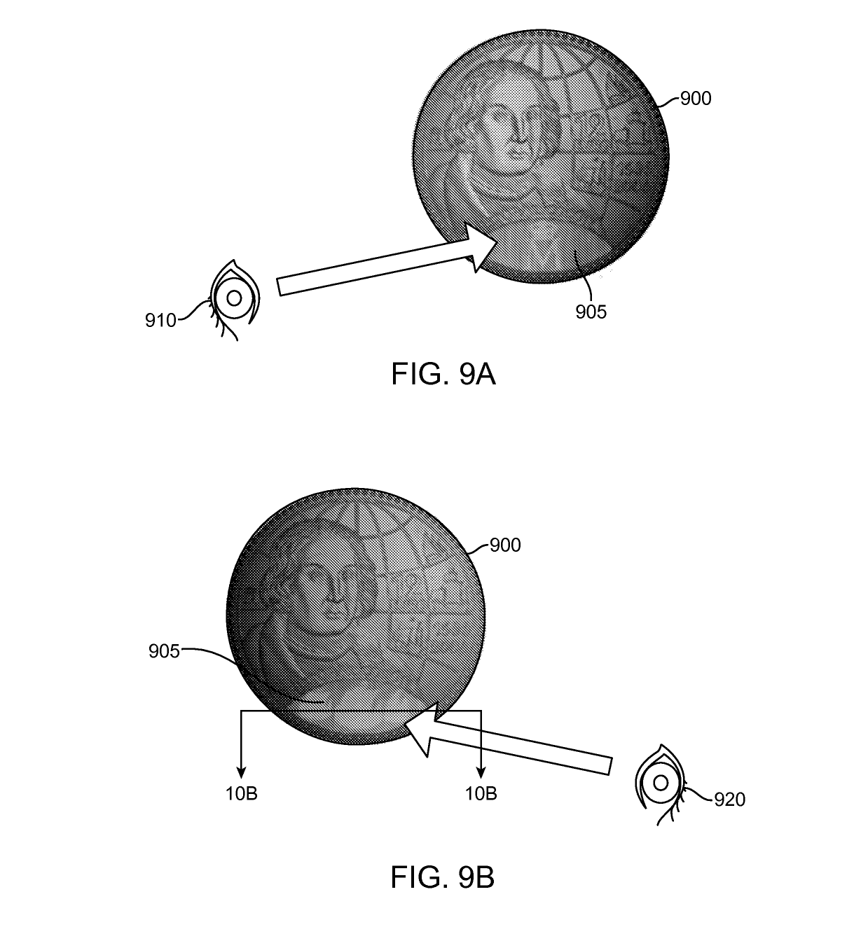

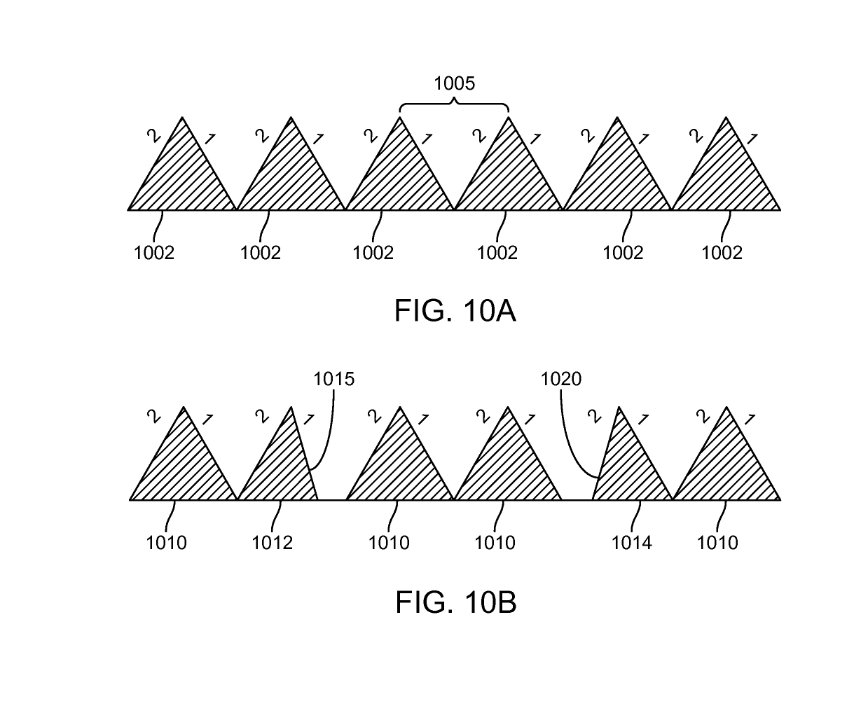

The examples described above are generally applicable to forming multi-shade latent images using intaglio printing, laser engraving, embossing, perforations, or the like. The following examples are generally applicable to forming multi-shade latent images using three-dimensional structures such as furrows, pyramids, triangles, or the like. FIGS. 9A, 9B, and 10 illustrate examples of an article that utilizes parallel furrows with triangular profiles to achieve two distinct latent images. Another approach for creating latent images in hard surfaces is described in EP0650853, which was introduced by the Royal Spanish Mint on the commemorative Christopher Columbus coin. With reference to FIG. 9A, when the coin 900 is tilted in a first direction to obtain a glancing view of image area 905 from perspective 910, a first latent image is observed depicted as a crown and “M” design. With reference to FIG. 9B, when the coin 900 is tilted in an opposite direction to obtain a glancing view of image area 905 from perspective 920, a second latent image is observed providing a pictorial of ships. When the coin 900 is viewed straight-on, no images are observed in the image area 905.

FIG. 10A illustrates a cross-section of parallel furrows 1002 that will be modified to create two latent images such as those illustrated in the image area 905 of FIGS. 9A and 9B. According to one example, the parallel furrows 1002 have triangular profiles 1005. With reference to FIG. 10A, one side of each furrow 1002 is marked with a number 1. Sides marked with the number 1 will be modified to represent a first latent image. An opposite side of each furrow 1002 is marked with number 2. Sides marked with the number 2 will be modified to represent a second latent image. With reference to FIG. 10A, each furrow 1002 has a same cross-sectional shape which signifies that no image content has been provided thereon. One of ordinary skill in the art will appreciate that structures raised relative to a substrate may be implemented as structured depressed into the substrate.

FIG. 10B illustrates a cross-section of image area 905 from FIG. 9B. According to one example, parallel furrow 1012 is illustrated with a furrow wall 1015 having a changed inclination on a side marked with number 1 to signify that a first latent image content is provided thereon. Specifically, parallel furrow 1012 has a cross-sectional shape that includes a steep slope for the side marked with the number 1 and a less steep slope for the side marked with the number 2.

Furthermore, parallel furrow 1014 is illustrated with a furrow wall 1020 having a changed inclination on a side marked with number 2 to signify that second latent image content is provided thereon. Parallel furrow 1014 has a cross-sectional shape that includes a less steep slope for the side marked with the number 1 and a steep slope for the side marked with the number 2. Accordingly, parallel furrows 1012 and 1014 have been modified to create two latent images such as those illustrated in the image area 905 of FIGS. 9A and 9B.

By contrast, parallel furrows 1010 in FIG. 10B each have a same cross-sectional shape when compared to corresponding parallel furrows 1002 in FIG. 10A, which signifies that no image content has been provided on parallel furrows 1010. Stated differently, each parallel furrow 1010 and parallel furrow 1002 has a same cross-sectional shape that includes a same slope for sides marked with the number 1 and sides marked with the number 2.

According to one example, changing an inclination or slope of the furrow walls between two predefined slopes changes an amount of reflected light that reaches an observer's eye from the latent image sections and from the background image sections. Accordingly, an observer holding the coin 900 at the first glancing angle from the perspective of 910 will observe a contrast between the first latent image and the background image.

The same effect is achieved when the glancing angle is changed to the perspective of 920. In this case, the opposite set of furrows walls is observed when the coin 900 is rotated by 180°. Changes an inclination or slope between the sections of the second latent image and the sections of the background image causes reflectivity changes, thus making the second latent image noticeable to the observer.

Conventional latent image designs fail to provide latent images having image elements configured to render multiple shade values. In other words, conventional latent image designs are either on-off such that they only support two tonal values throughout each security design with latent image effect. Accordingly, the content of the latent image for conventional latent image designs is perceived as a light or a dark silhouette, as illustrated in FIGS. 6A-6C. Therefore, the latent image at any given glancing angle of view is observed as a binary image having a silhouette and a contrasting background with perceived binary values depending on the angle of view.

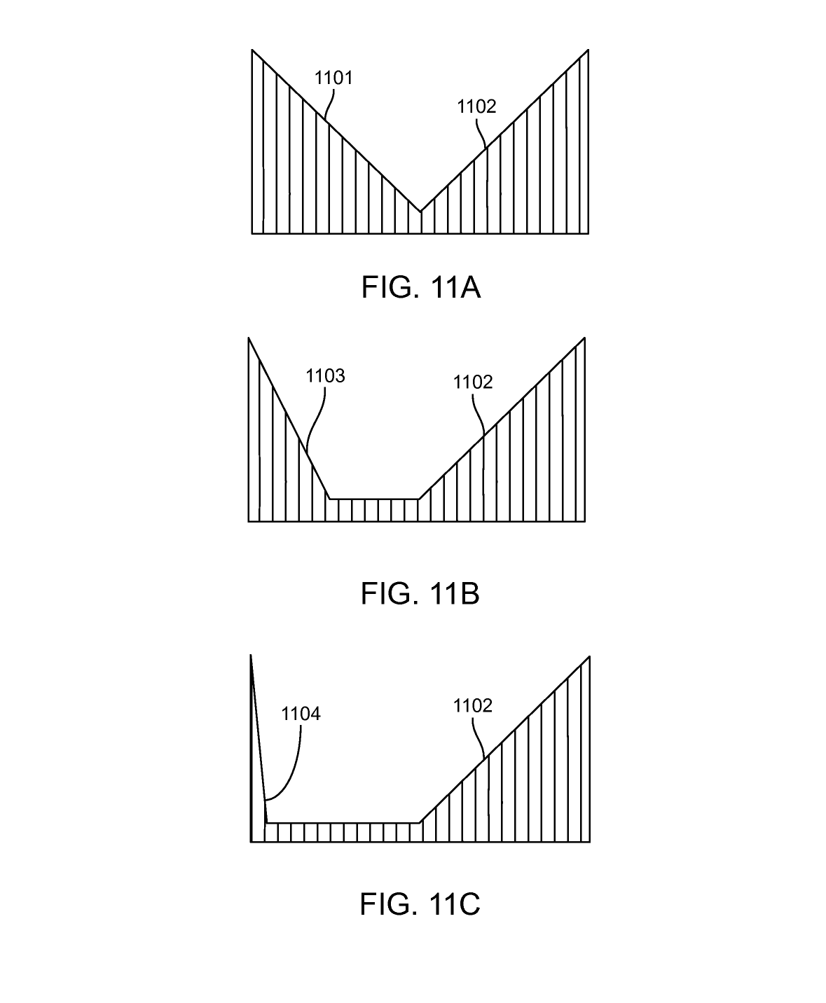

This disclosure describes techniques for creating multi-shade latent images. In contrast, existing technologies provide binary shade latent images. FIGS. 11A-11C illustrate cross sections of a novel structures used to embed a multi-shaded latent image into an encoded security image. According to one example, a slope of the furrow walls is changed when the latent image is embedded into the background image. Furthermore, a grid is overlaid on the source image to correspond to the multi-shaded latent image and an average shade value is calculated within the corresponding grid elements. The wall slopes of a substrate are modified in a manner proportional to the average shade value at positions that match a corresponding grid element.

With reference to FIG. 11A, a wall slope 1102 represents a referent slope that has no associated content. Wall slope 1102 corresponds to a white or light shaded element in a latent image. Wall slope 1101 also represents a referent slope having no associated content. With reference to FIG. 11B, wall slope 1103 has a steep slope compared to wall slope 1102 and corresponds to a darker shade compared to wall slope 1102. With reference to FIG. 11C, wall slope 1104 has an even steeper slope compared to wall slope 1103 and corresponds to an even darker shade compared to wall slope 1103. One of ordinary skill in the art will readily appreciate that a greater number of average shade values may be accommodated if more complex structures are used. For example, at least four multiple shade latent images may be accommodated if the embossing structure is a pyramid with a square base. One of ordinary skill in the art will readily appreciate that embossing may be used to create these structures, among other techniques.

FIGS. 11A-C illustrates how a wall slope may be modulated along a single furrow profile corresponding to three successive grid elements. With reference to a left-side profile, a shade of the first latent image changes from white at wall slope 1101 to black at wall slopes 1103, 1104. Separately, with reference to a right-side profile, a shade in the second latent image remains white at wall slopes 1102, 1102, 1102.

According to one example, two different extreme slope levels that match the white and the black content in the latent image are established depending on the technical capabilities of a CNC machine, an intaglio plate making system, or other device used to create embossed profiles. For example, a slope that matches the white content depends on the depth of the furrows. A slope that matches the black content depends on a structural strength of the plate and the substrate. Namely, if a slope for a dark shade approaches 90 degrees, the corresponding furrow wall may collapse if an adjacent furrow wall also has a slope close to 90 degrees. Once an appropriate slope range is established that avoids structural collapses and provide sufficient shade characteristics, then the slopes may be proportionally assigned to the multiple shade values as calculated in equation 1 above. Linear functions provided in equation 1 may not be needed to assign slope values for average shade levels. As discussed above, log, exponential, parabolic, or any other equations or functions may be used for particular applications.

Generally, a glancing view angle for the slope-based methods illustrated in FIGS. 11A-C will be steeper compared to the methods described above for changing rotation angles of the line segments. The glancing view angle may be approximately similar for the referent slope angle assigned to white grid elements, as shown in FIG. 11, slopes 1101, 1102.

According to one example, the wall geometry of embossed elements may be straight or curved. For example, the wall geometry may follow an elliptical profile. According to one example, an eccentricity of an ellipsis may be changed depending on an average gray level desired at a corresponding grid element.

According to another example, a multiple shade latent image may be featured inside encoded security images by modulating a height of the raised elements or a depth of the embossed elements on the substrate. For example, shade values may be used to control the height or depth factor. For example, a grid may be placed over the multiple shade latent image and an average shade value may be calculated inside each corresponding grid element. A darkest shade value may be mapped to a deepest valley in the substrate and a brightest shade value may be mapped to a shallow or entirely flat element on the substrate. One of ordinary skill in the art will readily appreciate that different valley profiles may be used, such as a triangular profile, a parabolic profile, a pyramid profile, an inverted pyramid profile, or the like. Also, different grids may be used, such as a square grid, a hexagonal grid, a honeycomb grid, or the like.

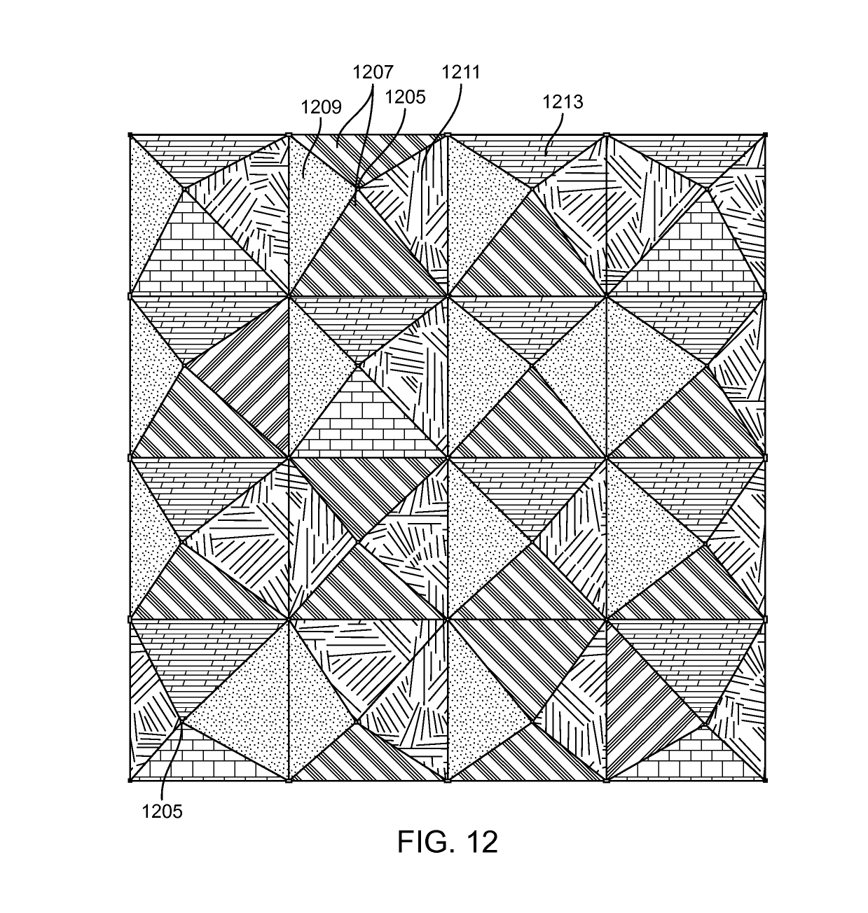

According to one example, FIG. 12 illustrates a top view of pyramid structures 1205 having a square base and four faces that may be configured to accommodate multiple shade latent images thereon. The faces of the pyramid structure 1205 are depicted with patterns thereon to represent image content. For example, face 1207 includes a first pattern that represents a first image content, face 1209 includes a second pattern that represents a second image content, face 1211 includes a third pattern that represents represent a third image content, and face 1213 includes a fourth pattern that represents a fourth image content. The various patterns may be applied to any face to create a desired multi-shade latent image. For example, multiple colors or shades of color may be provided on faces of the pyramid structures 1205. Furthermore, different colors may be applied to different faces of the pyramid structures 1205. This disclosure supports latent images that include shades of any color or colors, in addition to shades of gray.

Based on an observer's viewing perspective, corresponding faces of the pyramid structures 1205 will support a multiple shade latent image. According to one example, the pyramid structures 1205 having different colors applied to different faces may provide color switching or color fusion effects based on changes to a viewing perspective or glancing angle. According to one example, the pyramid structures 1205 may support four separate multiple shade latent images when viewed from four different perspectives corresponding to the four sides of the pyramid structures 1205.

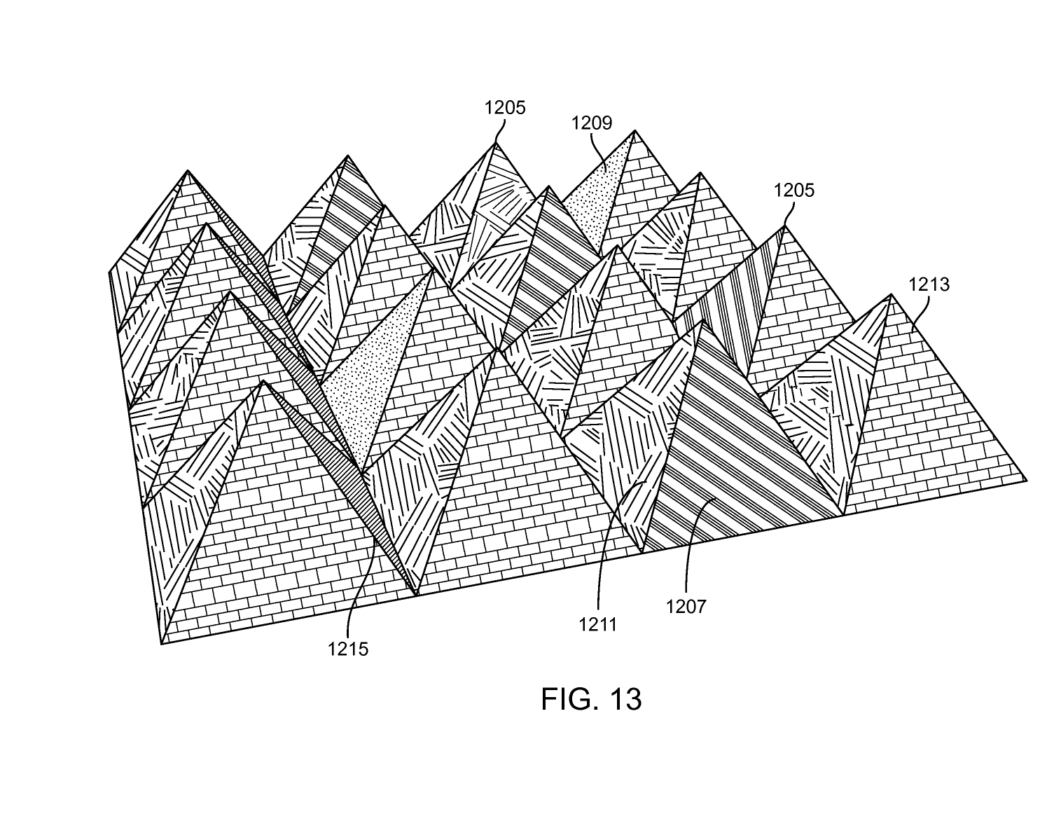

FIG. 13 illustrates a perspective view the pyramid structures 1205 having a square base and four faces that may be configured to accommodate multiple shade latent images thereon. The faces of the pyramid structure 1205 are depicted with patterns thereon to signify image content. For example, face 1207 includes a first pattern that represents a first image content, face 1209 includes a second pattern that represents a second image content, face 1211 includes a third pattern that represents represent a third image content, face 1213 includes a fourth pattern that represents a fourth image content, face 1215 includes a fifth pattern that represents a fifth image content. The various patterns may be applied to any face to create a desired multi-shade latent image. Based on an observer's viewing perspective, corresponding faces of the pyramid structures 1205 will support a multiple shade latent image. According to one example, the pyramid structures 1205 may support four separate multiple shade latent images when viewed from four different perspectives corresponding to the four sides of the pyramid structures 1205.

According to one example, patterns on the sides of the pyramid structures 1405 are changed when the latent image is embedded into the background image. Furthermore, a grid is overlaid on a source image to correspond to the multi-shaded latent image and an average shade value is calculated within the corresponding grid elements. The patterns on the sides of the pyramid structures 1405 are modified in a manner proportional to the average shade value at positions that match a corresponding grid element.

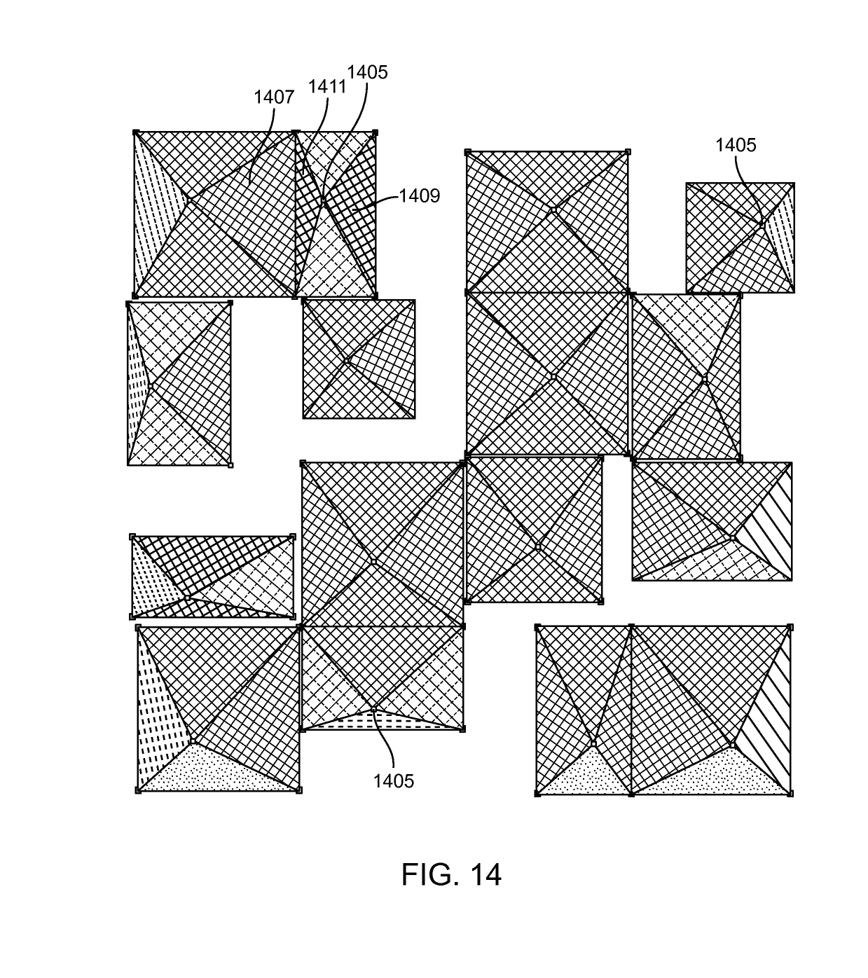

According to one example, FIG. 14 illustrates a top view of pyramid structures 1405 having four faces that may be configured to accommodate multiple shade latent images thereon. The faces of the pyramid structure 1405 are depicted with patterns thereon to signify that each face may include a preselected inclination angle that reflects light. Based on an observer's viewing perspective, corresponding faces of the pyramid structures 1405 will support a multiple shade latent image. The various preselected inclination angles may be applied to create a desired multi-shade latent image. For example, face 1407 includes a first preselected inclination angle that reflects light according to a first characteristic, face 1409 includes a second preselected inclination angle that reflects light according to a second characteristic, face 1411 includes a third preselected inclination angle that reflects light according to a third characteristic, and so forth. According to one example, the pyramid structures 1405 may support four separate multiple shade latent images when viewed from four different perspectives corresponding to the four sides of the pyramid structures 1405.

According to one example, a slope of the face inclinations for the pyramid structures 1405 are changed when the latent image is embedded into the background image. Furthermore, a grid is overlaid on a source image to correspond to the multi-shaded latent image and an average shade value is calculated within the corresponding grid elements. The face inclination slopes for the pyramid structures 1405 are modified in a manner proportional to the average shade value at positions that match a corresponding grid element.

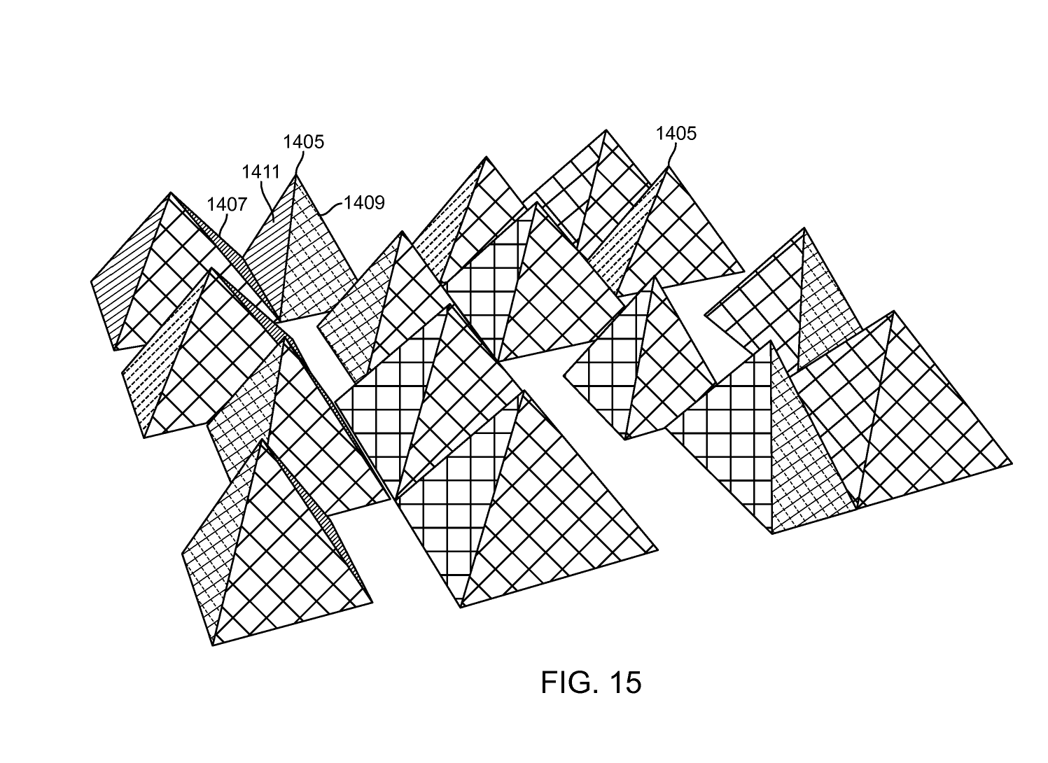

FIG. 15 illustrates a perspective view the pyramid structures 1405 having a square base and four faces that may be configured to accommodate multiple shade latent images thereon. The faces of the pyramid structure 1405 are depicted with patterns thereon to signify that each face may include a preselected inclination angle that reflects light. Based on an observer's viewing perspective, corresponding faces of the pyramid structures 1405 will support a multiple shade latent image. The various preselected face inclination angles may be applied to create a desired multi-shade latent image. For example, face 1407 includes a first preselected face inclination angle that reflects light according to a first characteristic, face 1409 includes a second preselected face inclination angle that reflects light according to a second characteristic, face 1411 includes a third preselected face inclination angle that reflects light according to a third characteristic, and so forth. According to one example, the pyramid structures 1405 may support four separate multiple shade latent images when viewed from four different perspectives corresponding to the four faces of the pyramid structures 1405.

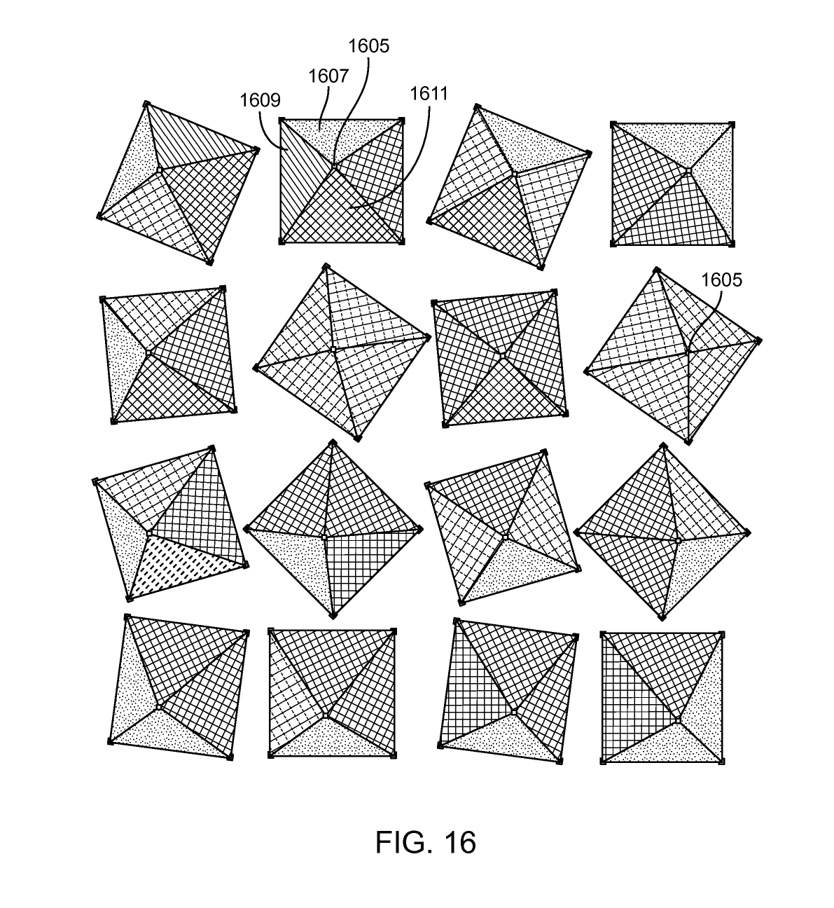

According to one example, FIG. 16 illustrates a top view of pyramid structures 1605 having a square base and four faces that may be configured to accommodate multiple shade latent images thereon. The faces of the pyramid structure 1605 are depicted with patterns thereon to signify image content. For example, face 1607 includes a first pattern that represents a first image content, face 1609 includes a second pattern that represents a second image content, and face 1611 includes a third pattern that represents represent a third image content. The various patterns may be applied to any face to create a desired multi-shade latent image. According to one example, the pyramid structures 1605 are rotated relative to each other to create multiple latent images. Based on an observer's viewing perspective, corresponding faces of the pyramid structures 1605 will support a multiple shade latent image. According to one example, the pyramid structures 1605 may support four separate multiple shade latent images when viewed from four different perspectives corresponding to the four faces of the pyramid structures 1605. This disclosure supports latent images that include shades of any color or colors, in addition to shades of gray.

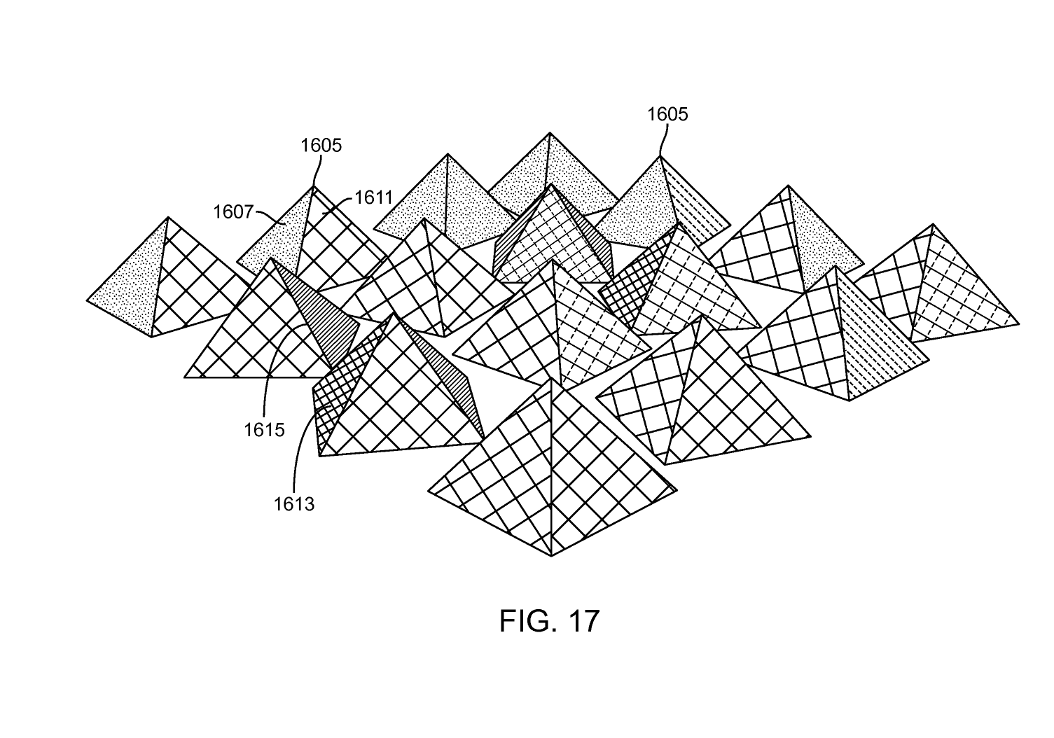

FIG. 17 illustrates a perspective view the pyramid structures 1605 having a square base and four faces that may be configured to accommodate multiple shade latent images thereon. The faces of the pyramid structure 1605 are depicted with patterns thereon to signify image content. For example, face 1607 includes a first pattern that represents a first image content, face 1609 includes a second pattern that represents a second image content, and face 1611 includes a third pattern that represents represent a third image content, face 1613 includes a fourth pattern that represents a fourth image content, face 1615 includes a fifth pattern that represents a fifth image content. According to one example, the pyramid structures 1605 are rotated relative to each other to create multiple latent images. The various patterns may be applied to any face to create a desired multi-shade latent image. Based on an observer's viewing perspective, corresponding faces of the pyramid structures 1605 will support a multiple shade latent image. According to one example, the pyramid structures 1605 may support four separate multiple shade latent images when viewed from four different perspectives corresponding to the four faces of the pyramid structures 1605.

According to one example, patterns on the sides of the pyramid structures 1605 are changed and the pyramid structures 1605 are rotated when the latent image is embedded into the background image. Furthermore, a grid is overlaid on a source image to correspond to the multi-shaded latent image and an average shade value is calculated within the corresponding grid elements. The patterns on the faces of the pyramid structures 1605 are modified and the pyramid structures 1605 are rotated in a manner proportional to the average shade value at positions that match a corresponding grid element.

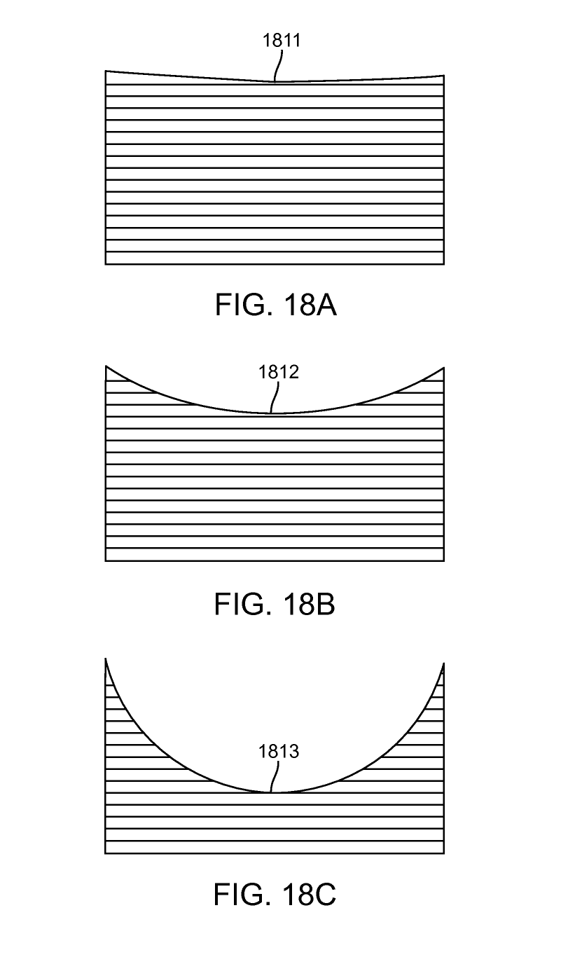

FIGS. 18A-C illustrate examples of how a depth of three successive grid elements may vary as an average shade value of a source image for a multi-shaded latent image varies from light to dark. With reference to FIG. 18A, a depth depicted by 1811 is a lightest shade. With reference to FIG. 18B, a depth depicted by 1812 is darker compared to the lightest shade. With reference to FIG. 18C a depth depicted by 1813 is darkest. Linear functions provided in equation 1 may not be needed to assign depth values for average shade levels. As discussed above, log, exponential, parabolic, or any other equations or functions may be used for particular applications.

According to the example described with reference to FIGS. 18A-C, a multiple shade background image may be used to control an area of the embossed elements. Similar to the discussion of combining angle/thickness modulation in FIG. 8, a dynamic range of the multiple shade values in the background image is preferably narrow. Otherwise, the system will need to distinguish between perceived brightness change due to the modification of the element area as controlled by the values in the multiple shade background image, and the brightness change due to the modification of the element depth as controlled by the values in the multiple shade latent image.

According to another example, a “transmitted” monochrome latent image may be achieved by a lack of occlusion of transmitting light, whereby positive (or lighter shaded) portions of the latent image are revealed in a lack of occlusion of light passing through the image when it is viewed by backlighting the document. This example benefits from some amount of transparency in the substrate that the monochrome latent image is located on. There are several ways transparency may be introduced into a substrate, including for example, overprinting a transparent window in a document with intaglio or a same effect may be introduced by perforation. Perforation may include traditional perforation, laser ablation and ‘simulated perforation’, performed by printing a mask over a transparent area. The perforation elements may change in shape to control an amount of light that passes through them at different angles of view.

According to this example, longer perforation elements will allow transmitting light to pass through when tilting the document as it is backlit. For example, darker areas of the monochrome latent image may be created using square or circular perforations, while lighter areas may be created using rectangular or oval perforations. Another point to consider with this method is the orientation of the perforation elements. For example, it is possible to have more than one latent image in a same area by having more than one angle of view orientation such as some elements are oriented at 0 degrees and others are oriented at 90 degrees.

Another way this transmitted monochrome latent image can be achieved is by varying an incidence angle for the perforation elements. Typically, perforations have an incidence angle that is perpendicular to a document and pass straight through. If an angle of the perforation elements is changed so that certain elements allow light through at steeper angles of view than others, this can be controlled to create a transmitted monochrome latent image.

While the foregoing illustrates and describes examples of this invention, it is to be understood that the invention is not limited to the constructions disclosed herein. The invention can be embodied in other specific forms without departing from its spirit. Accordingly, the appended claims are not limited by specific examples described herein.

We claim:

1. An article of manufacture, comprising:
a surface; and
image elements provided on the surface, the image elements having characteristics that correspond to a relative color or a relative shade of a source image for a polychromic or multiple shade latent image, the latent image being visible when the surface is viewed at glancing angles.

2. The article according to claim 1, wherein the image elements characteristics include at least one of a rotation angle of the image elements, an elongation of image elements, a shape of the image elements, a depth the image elements penetrate into the substrate, a perforation feature of the image elements, and an embossing feature of the image elements.

3. The article according to claim 2, wherein the image elements are formed from at least one of dots, solid lines, dashed lines, diamonds, polygons, and elliptical structures.

4. The article according to claim 3, wherein the image elements include at least a thickness, color, and shape that correspond to the relative shade and the relative color of a background image.

5. The article according to claim 1, wherein the image elements comprise furrows with triangular profiles.

6. The article according to claim 5, wherein the image element characteristics for the furrows include an inclination angle of sides of the furrows.

7. The article according to claim 6, wherein each side of the furrows represents a different latent image.

8. The article according to claim 1, wherein the image elements comprise pyramid structures having a plurality of faces.

9. The article according to claim 8, wherein the pyramid structures are raised above the surface or indented into the surface, the image element characteristics for the pyramid structures include an inclination angle for faces of the pyramids.

10. The article according to claim 9, wherein each face of the pyramid structure represents a different latent image.

11. The article according to claim 8, wherein the image element characteristics for the pyramid structures include at least one of an inclination angle of the faces of the pyramid structures and an angular orientation of the pyramid structures.

12. The article according to claim 1, wherein the image elements comprise at least one of a semi spherical and ovoid indentation.

13. The article according to claim 12, wherein the image element characteristics for the semi spherical and the ovoid indentation include an indentation depth.

14. The article according to claim 1, wherein the image elements comprise perforations.

15. The article according to claim 14, wherein the image element characteristics for the perforations include a perforation angle relative to the substrate.

16. A method of creating a multiple shade latent image, the method comprising:
dividing a source image into a grid pattern having grid elements, the grid elements having corresponding image elements;
averaging one of shade values or color values within the grid elements;
determining an average shade value or an average color value within the grid elements;
determining image element characteristics that correspond to the average shade value or the average color value; and
applying the image element characteristics to the image elements within corresponding grid elements.

17. The method according to claim 16, wherein the image elements are formed using one of intaglio printing, embossing, perforation, laser engraving, laser ablation and features of a computer numerical control machine.

18. The method according to claim 16, wherein applying the image element characteristics to the image elements comprises mapping the average shade value within a corresponding grid element to a rotation angle of the image elements.

19. The method according to claim 17, wherein the image elements are formed from at least one of dots, solid lines, dashed lines, diamonds, polygons, and elliptical structures.

20. The method according to claim 18, further comprising assigning a positive value or a negative value to a rotation angle of the image elements.

21. The method according to claim 20, further comprising applying at least one of a thickness, a color, and a shape to the image elements to correspond to the average shade value or the average color value of a background image.

22. The method according to claim 16, wherein applying the image element characteristics to the image elements comprises mapping the average shade values within a corresponding grid element to an inclination angle of at least one side of a furrow having a triangular profile.

23. The method according to claim 22, further comprising using an additional source image to modify a second side of the furrow by:
dividing an additional source image into a second grid pattern having second grid elements, the second grid elements having corresponding second image elements;
averaging one of shade values or color values within the grid elements for the additional source image;
determining an average shade value or an average color value within the grid elements for the additional source image;
determining second image element characteristics that correspond to the average shade value or the average color value for the additional source image; and
applying the second image element characteristics to the second image elements within corresponding grid elements, the second image elements corresponding to the second side of the furrow.

24. The method according to claim 16, wherein the step of applying the image element characteristics to the image elements comprises mapping the average shade values within a corresponding grid element to an inclination angle of at least one face of a pyramid structure.

25. The method according to claim 24, further comprising using an additional source image to modify a second face of the pyramid structure by:
dividing an additional source image into a second grid pattern having second grid elements, the second grid elements having corresponding second image elements;
averaging one of shade values or color values within the grid elements for the additional source image;
determining an average shade value or an average color value within the grid elements for the additional source image;
determining second image element characteristics that correspond to the average shade value or the average color value for the additional source image; and
applying the second image element characteristics to the second image elements within corresponding grid elements, the second image elements corresponding to the second face of the pyramid structure.

26. The method according to claim 16, wherein applying the image element characteristics to the image elements comprises mapping the average shade values within a corresponding grid element to a height or a depth of depressions or protrusions in a substrate.

27. The method according to claim 16, wherein applying the image element characteristics to the image elements comprises mapping the average shade values within a corresponding grid element to a perforation angle relative to a substrate.
